(19) United States
(12) Patent Application Publication
(10) Pub. No.: US 2023/0327190 A1
(43) Pub. Date: Oct. 12, 2023

(54) SOLID-STATE BATTERY AND METHOD FOR MANUFACTURING SAME BY PROTONATION

(71) Applicants: The Swatch Group Research and Development Ltd, Marin (CH); EMPA, Swiss Federal Laboratories for materials Testing and Research, Dübendorf (CH)

(72) Inventors: Rabeb GRISSA, Neuchâtel (CH); Corsin Battaglia, Lindau (CH)

(73) Assignees: The Swatch Group Research and Development Ltd, Marin (CH); EMPA, Swiss Federal Laboratories for materials Testing and Research, Dübendorf (CH)

(21) Appl. No.: 18/187,432

(22) Filed: Mar. 21, 2023

(30) Foreign Application Priority Data
Apr. 8, 2022 (EP) 22167459.1

(51) Int. Cl. H01M 10/0562; H01M 10/0585; H01M 4/04; H01M 4/38; H01M 4/505; H01M 4/525; H01M 4/58; H01M 4/134; H01M 4/131; H01M 4/136; H01M 4/1395; H01M 4/1391; H01M 4/1397

(52) U.S. Cl. CPC H01M 10/0562; H01M 2004/027; H01M 4/0407; H01M 4/382; H01M 4/0445; H01M 4/505; H01M 4/525; H01M 4/5825; H01M 4/134; H01M 4/131; H01M 4/136; H01M 4/1395; H01M 4/1391; H01M 4/1397; H01M 2300/0071; H01M 2300/008; H01M 2300/0068; H01M 10/0585

(57) ABSTRACT

A solid-state battery (20) with a solid electrolyte (8) and to the method for producing same. The method includes: protonating a body (11) containing, preferably being entirely made of, a protonatable ceramic material, to form a protonated layer (12, 13) on the body (11); depositing a metal element forming an anode (14) on the protonated layer (13) on a first side (7) of the body (11); assembling a cathode (15) on a second side (9) of the body (11), preferably opposite the first side (7) of the anode (14); and forming dendrites (18) from the metal element in the protonated layer (13) of the body (11).

### CROSS REFERENCE TO RELATED APPLICATIONS

This application is a non-provisional application, claiming priority based on European Patent Application No. 22167459.1 filed Apr. 8, 2022.

### TECHNICAL FIELD OF THE INVENTION

The invention relates to solid-state batteries, also referred to as “all solid-state batteries”.

The invention further relates to the method for manufacturing such a solid-state battery.

The invention further relates to electronic systems, such as a watch, a laptop computer, a mobile phone or a motor vehicle, including such a solid-state battery.

### TECHNOLOGICAL BACKGROUND

Solid-state or all solid-state batteries are alternatives to lithium-ion type cells. Unlike the latter, which include a liquid electrolyte, all solid-state batteries have a solid electrolyte disposed between an anode and a cathode.

Such batteries have the advantage of having a higher energy density than lithium-ion batteries, and thus have a higher storage capacity, which is promising in many fields of application.

Ceramic compounds such as LLZO compounds, are known to be used as a solid electrolyte.

The LLZO-type compound has a high ionic conductivity. This ceramic compound contains lithium, lanthanum, zirconium and oxygen and has, for example, the chemical formula Li₇La₃Zr₂O₁₂ or Li₇La₃Zr₂O₇. It can also be doped with tantalum or aluminium to stabilise the cubic phase thereof, which is conductive to lithium ions. It then has, for example, the chemical formula Li_{6.4}La₃Zr₂Ta_{0.6}O₁₂.

One drawback of ceramic compounds is the contact between the anode, which is for example made of lithium, and the solid electrolyte. More specifically, preventing the presence of impurities and asperities between the two elements is important, as they create constriction currents and cavities, which lead to the formation of lithium dendrites that pass through the ceramic compound and produce short circuits. This is because these constriction currents can exceed a current threshold value, which causes dendrites to appear, in particular lithium dendrites, in the ceramic compound.

One solution to this problem is to dispose a conductive liquid between the ceramic compound and the lithium anode. This improves the contact between the two.

However, the same problems associated with batteries containing a liquid electrolyte are encountered, in particular the risk of the liquid leaking outside the battery, and the consequences thereof. Furthermore, the presence of a liquid does not overcome the risk of lithium dendrite formation.

### SUMMARY OF THE INVENTION

The purpose of the invention is to overcome the aforementioned drawbacks, and it aims to provide a method for producing a solid-state battery which improves the contact between the anode and the solid electrolyte, without the use of a liquid contact element.

To this end, the invention relates to a method for producing a solid-state battery.

The invention is noteworthy in that the method comprises the following successive steps:
a step of protonating a body containing, preferably being entirely made of, a protonatable ceramic material, to form a protonated layer on the body,
a step of depositing a metal element forming an anode on the protonated layer on a first side of the body,
a step of assembling a cathode on a second side of the body, preferably opposite the first side of the anode, and
a step of forming dendrites from the metal element in the protonated layer of the body.

The protonated layer of the ceramic is softer than the original ceramic, such that it is easier to form dendrites in this layer. The dendrites improve the contact between the metal element and the body of the solid electrolyte, in particular because the contact area is increased by the contact irregularities formed by the dendrites. Moreover, the remaining unprotonated part of the body, which is harder, prevents these dendrites from propagating to the cathode and causing a short circuit. Furthermore, the risk of constriction currents appearing, and thus of dendrites forming in this unprotonated part is prevented.

According to one specific embodiment of the invention, the ceramic material is selected from among:
doped or undoped lithium and/or lanthanum zirconium oxide, of the LLZO type,
a doped or undoped beta-alumina solid electrolyte material of the Na-b″-Al₂O₃ type,
a ternary, quaternary or higher order sulphide-based solid electrolyte material, for example of the Li₆PS₅X type (where X is selected from the elements Cl, Br or I) or of the Li₂S—P₂S₅ type,
a ternary, quaternary or higher order halogen-based solid electrolyte material, for example of the Li₃MX₆ type (where M is a metal or a metal alloy, and X is a halogen),
a lithium ion-conducting solid electrolyte material of the LISICON (lithium super ionic conductor) type, for example of the Li_{4±x}XₓO₄ type (where X is selected from the elements P, AI, or Ge), and
a sodium ion-conducting solid electrolyte material of the NASICON (sodium super ionic conductor) type, for example of the NaₓMM′(XO₄)₃ type (where M and M′ are metals and X is selected from the elements Si, P or S).

According to one specific embodiment of the invention, in the protonation step, the body is immersed in a protic or acidic solvent, such as water, acetone, mineral oil or ethanol.

According to one specific embodiment of the invention, the method includes an additional step of heating the body to a predefined temperature in order to clean the body of impurities, the predefined temperature preferably being between 350° C. and 450° C., the additional heating step preceding the step of depositing the metal element.

According to one specific embodiment of the invention, the dendrite formation step comprises a repeated succession of current flow cycles between the anode and the cathode.

According to one specific embodiment of the invention, the metal element is melted onto the body during the metal element deposition step.

According to one specific embodiment of the invention, the metal element contains a material selected from among:
alkali-metals, such as lithium, sodium, potassium, rubidium, caesium or francium,
alkaline-earth metals, such as beryllium, magnesium, calcium, strontium, barium or radium,
all transition metals, which make up columns 3 to 11 of the periodic table, including lanthanides and actinides, and
alloys of these metals.

According to one specific embodiment of the invention, the method comprises an additional step of removing a part of the protonated layer from the body in order to deposit the cathode directly onto the unprotonated part of the body.

According to one specific embodiment of the invention, the additional step of removing a part of the protonated layer from the body is carried out by polishing the second side of the body.

According to one specific embodiment of the invention, the cathode contains a material selected from among:
a lithium-nickel-manganese-cobalt oxide of the NMC type, such as LiNixMnyCozO2 or Li2-x-y-zNixMnyCozO2 where x+y+z≤1,
a lithium-nickel-manganese oxide of the LNMO type, such as LiNi0.5Mn1.5O4,
a lithium iron phosphate oxide of the LFP type, such as LiFePO4,
a lithium manganese oxide of the LMO type, such as LiMn2O4, and
a lithium-nickel-cobalt-aluminium oxide of the NCA type, such as LiNiCoAlO2.

The invention further relates to a solid-state battery comprising an anode, a cathode, and a ceramic solid electrolyte, characterised in that the solid electrolyte is provided with a protonated layer and an unprotonated part superimposed on one another, the cathode being deposited on the body, the anode comprising a metal element deposited on the protonated layer of the body opposite the cathode, the metal element comprising dendrites that have infiltrated the protonated layer of the body.

According to one specific embodiment of the invention, the dendrites are blocked by the unprotonated part of the body.

According to one specific embodiment of the invention, the metal element contains a material selected from among:
alkali-metals, such as lithium, sodium, potassium, rubidium, caesium or francium,
alkaline-earth metals, such as beryllium, magnesium, calcium, strontium, barium or radium,
all of the so-called transition metals, which make up columns 3 to 11 of the periodic table, including lanthanides and actinides, and
alloys of these metals.

According to one specific embodiment of the invention, the ceramic material is selected from among:
doped or undoped lithium and/or lanthanum zirconium oxide, of the LLZO type,
a doped or undoped beta-alumina solid electrolyte material of the Na-b″-Al₂O₃ type,
a ternary, quaternary or higher order sulphide-based solid electrolyte material, for example of the Li6PS5X type (where X is selected from the elements Cl, Br or I) or of the Li2S-P2S5 type,
a ternary, quaternary or higher order halogen-based solid electrolyte material, for example of the Li3MX6 type (where M is a metal or a metal alloy, and X is a halogen),
a lithium ion-conducting solid electrolyte material of the LISICON (lithium super ionic conductor) type, for example of the Li_{4±x}Si₁₋ₓXxO₄ type (where X is selected from the elements P, Al, or Ge), and
a sodium ion-conducting solid electrolyte material of the NASICON (sodium super ionic conductor) type, for example of the NaxMM′(XO4)3 type (where M and M′ are metals and X is selected from the elements Si, P or S).

According to one specific embodiment of the invention, the cathode is bonded to the unprotonated part of the body.

According to one specific embodiment of the invention, the cathode contains a material selected from among:
a lithium-nickel-manganese-cobalt oxide of the NMC type, such as LiNixMnyCozO2 or Li2-x-y-zNixMnyCozO2 where x+y+z≤1,
a lithium-nickel-manganese oxide of the LNMO type, such as LiNi0.5Mn1.5O4,
a lithium iron phosphate oxide of the LFP type, such as LiFePO4,
a lithium manganese oxide of the LMO type, such as LiMn2O4, and
a lithium-nickel-cobalt-aluminium oxide of the NCA type, such as LiNiCoAlO2.

The invention further relates to an electronic system, for example a watch, a drone, a laptop computer, a mobile phone or a motor vehicle, comprising such an all solid-state battery.

### BRIEF DESCRIPTION OF THE FIGURES

Other specific features and advantages will be clearly observed in the following description, which is given as a rough guide and in no way as a limiting guide, with reference to the accompanying drawings, in which:

FIG. 1 is a block diagram showing the steps of the method according to the invention; and

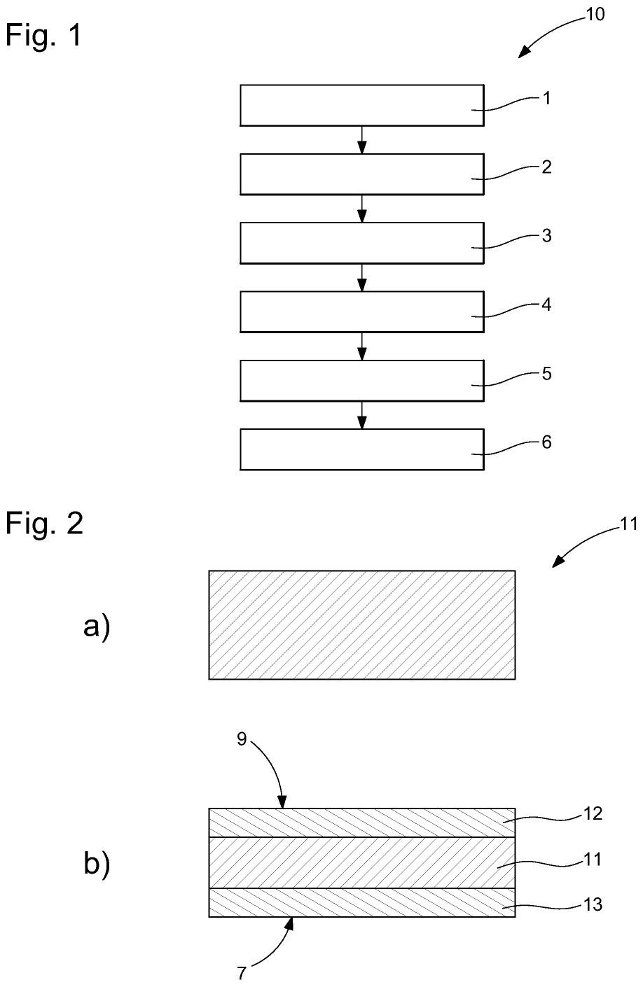

FIGS. 2a) to 2f) are diagrammatic, cross-sectional views of the battery after each step of the method for producing the battery according to the invention.

### DETAILED DESCRIPTION OF THE INVENTION

The invention relates to a method for producing 10 a solid-state battery 20. Such a battery 20 comprises an anode 14, a cathode 15 and an electrolyte arranged between the cathode 15 and the anode 14. A solid electrolyte 8 is understood to refer to an electrolyte that is not liquid.

The electrolyte 8 is formed from a body 11 containing a material capable of undergoing protonation. In other words, it is able to exchange H⁺ ions with protons. Preferably, the body 11 is made entirely of this material.

The ceramic material used can be selected from:
doped or undoped lithium and/or lanthanum zirconium oxide, the LLZO type,
a doped or undoped beta-alumina solid electrolyte material of the Na-b″-Al2O3 type,
a ternary, quaternary or higher order sulphide-based solid electrolyte material, for example of the Li₆PS₅X type (where X is selected from the elements CI, Br or I) or of the Li₂S—P₂S₅ type,
a ternary, quaternary or higher order halogen-based solid electrolyte material, for example of the Li₃MX₆ type (where M is a metal or a metal alloy, and X is a halogen),
a lithium ion-conducting solid electrolyte material of the LISICON (lithium super ionic conductor) type, for example of the Li_{4±x}Si₁₋ₓXₓO₄ type (where X is selected from the elements P, Al, or Ge), and
a sodium ion-conducting solid electrolyte material of the NASICON (sodium super ionic conductor) type, for example of the NaₓMM′(XO₄)₃ type (where M and M′ are metals and X is selected from the elements Si, P or S).

The ceramic material is preferably made entirely of this material.

Preferably, the LLZO-type compound is selected, as it has a high ionic conductivity.

In order to produce the battery 20, a method is used which comprises a first step of protonating 1 the ceramic body 11. The body 11 is immersed in a protic or acidic solvent, such as water, acetone, mineral oil or ethanol, in order to replace atoms of the ceramic with a proton. Preferably, water is selected as the protic solvent.

The body is immersed for a long period of time, at least for one day, preferably several days or even a week or more, depending on the size of the body 11 and the desired protonated layer.

The body is, for example, shaped like a pellet with a thickness of 0.7 mm to form a small battery 20. The body has preferably been previously polished to have parallel faces.

Preferably, in order to speed up the process, the liquid is heated to a predetermined temperature, for example 50° C.

In the case of the LLZO-type compound, the protonation formula with water is as follows:

LLZO+H₂O→HLLO+LiOH

Regardless of the liquid used, the protonated compound of the HLLZO-type is obtained. The protonated HLLZO-type compound is softer than the unprotonated LLZO-type compound, which is a very hard ceramic.

At the end of this step, the body 11 comprises a protonated layer 12, 13 around the body 11. The layer 12, 13 is disposed around the entire body 11, if the body is fully immersed in the liquid.

The layer has a thickness of 20 μm for example. A first layer 13 is disposed on a first side 7 of the body 11, and a second layer 12 is disposed on a second side 9 of the body 11.

The method 10 includes a second step of removing 2 the second protonated layer 12 from the second side 9 of the body 11 so that the cathode 15 can be deposited directly on an unprotonated part of the body 11 in a subsequent step. This is because the conductivity between the cathode 15 and an unprotonated part is better than between a cathode 15 and a protonated part.

Preferably, the second removal step 2 comprises polishing the second side 9 of the body 11. Polishing removes the protonated layer of material 12 to expose an unprotonated part of the body 11. For example, a 600 grit polishing tool is used to remove the HLLZO-type protonated layer.

In a third step 3, the body 11 is heated to a predefined temperature in order to clean the body 11 of impurities. The predefined temperature is preferably between 300 and 500° C., preferably between 350° C. and 450° C. This temperature range prevents the denaturation or decomposition of the material of the body 11, whether protonated or not. In particular, the carbonate-type molecules are sought to be removed from the surface of the body 11, as they increase the resistance at the interface between the electrode and the electrolyte. The heating time is, for example, equal to three hours.

The fourth step 4 consists of depositing a metal element forming an anode 14 on the protonated part on the first side of the body 11. The first side 7 is selected such that it is opposite the second side 9 of the body 11. Thus, the cathode 15 and the anode 14 are arranged on either side of the body 11.

The metal element contains a material to be selected from:
alkali-metals, such as lithium, sodium, potassium, rubidium, caesium or francium,
alkaline-earth metals, such as beryllium, magnesium, calcium, strontium, barium or radium,
all transition metals, which make up columns 3 to 11 of the periodic table, including lanthanides and actinides, and
alloys of these metals.

The metal element is preferably made entirely of this material.

Preferably, lithium is selected for its physical and chemical properties that are conducive to use as an anode 14.

The molten metal element is deposited on the first protonated side 7 of the body 11. In other words, the metal element is deposited in a molten form on the first side 7. In this state, the metal element adheres to the body 11 on the first side 7, in particular to maximise the span of the contact face between the metal element and the body 11.

The method comprises a fifth step 5 of assembling a cathode 15 on the body 11 on the second side 9 opposite the anode 14, which is not protonated following the polishing that took place in the second step 2.

For this purpose, an adhesive 16 made of a polymer material is used to assemble them together, referred to as a catholyte, the adhesive 16 being an ion conductor allowing the ions to pass.

For example, a polymer adhesive 16 containing polyethylene oxide of the PEO type, a lithium salt of the LiTFSi (lithium bis-(trifluoromethanesulphonyl)-imide) type, and THF (Tetrahydrofuran) is used. The polymer adhesive 16 is dissolved in the THF (tetrahydrofuran) and then deposited on the second side 9, for example by means of a drop casting method. The cathode 15 is then deposited on the polymer adhesive 16 after the THF has dried, such that the cathode 15 permanently adheres to the second side 9.

The cathode 15 contains, for example, a material to be selected from:
a lithium-nickel-manganese-cobalt oxide of the NMC type, such as LiNiₓMn_{y}Co_{z}O₂ or Li_{2-x-y-z}NiₓMn_{y}Co_{z}O₂ where x+y+z≤1,
a lithium-nickel-manganese oxide of the LNMO type, such as LiNi_{0.5}Mn_{1.5}O₄,
a lithium iron phosphate oxide of the LFP type, such as LiFePO₄,
a lithium manganese oxide of the LMO type, such as LiMn₂O₄, and
a lithium-nickel-cobalt-aluminium oxide of the NCA type, such as LiNiCoAlO₂.

The cathode 15 is preferably mostly made of this material, together with the polymer adhesive and carbon to improve the ionic and electronic conductivity thereof.

The sixth step 6 consists of forming dendrites 18 in the remaining protonated layer 13 from the metal element of the anode 14. The dendrites 18 are elongated elements that penetrate the protonated layer 13, which is more fragile than the unprotonated part 11. The dendrites 18 are formed naturally by the flow of current. Cracks appear in the protonated layer 13, which are then filled with the metal element from the anode 14.

To this end, the sixth step 6 comprises a repeated succession of current flow cycles between the anode 14 and the cathode 15. During each cycle, a current is applied to the terminals of the battery, at the anode 14 and at the cathode. The current is, for example, selected so as to obtain 0.1 mA/cm².

Several cycles are carried out, preferably less than ten, while alternating the polarity of the current. A positive current follows a negative current, and vice-versa.

The dendrites 18, which are preferably made of lithium, penetrating the protonated layer 13 improve the quality of the ionic contact by increasing the contact area between the anode 14 and the solid electrolyte 8.

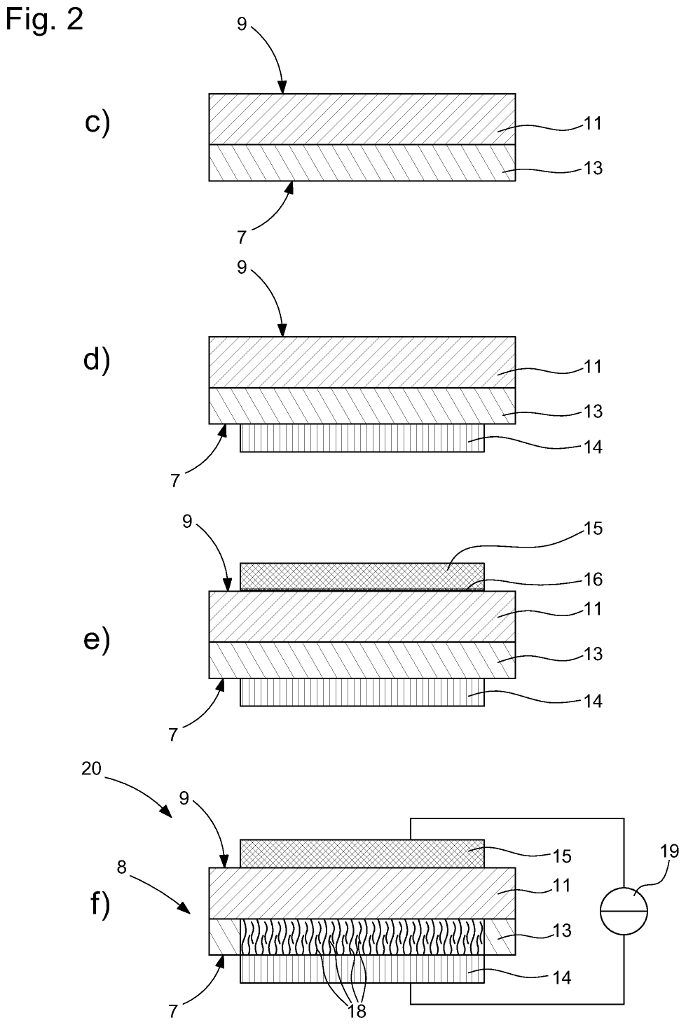

FIG. 2a) shows a body 11 made entirely of a LLZO-type ceramic material. After the first protonation step, the body 11 comprises a protonated layer 12, 13 around the body 11, as shown in FIG. 2b). A first layer 13 is arranged on a first side 7 of the body 11, and a second layer 12 is arranged on a second side 9 of the body 11.

The body 11 is then polished on the second side 9 of the body 11, so as to expose an unprotonated part on this side. The body 11 in FIG. 2c) thus has an unprotonated part on the second side 9 and a protonated layer 13 on a first side 7 of the body 11.

According to the fourth step, an anode 14 is formed on the first protonated side 7 of the body 11, by depositing a molten metal element, preferably made of lithium, as shown in FIG. 2d). The body 11 remains substantially the same after the fifth cleaning step.

A cathode 15 is bonded to the second, unprotonated side 9 of the body 11, using polymer adhesive 16, as shown in FIG. 2e).

FIG. 2f) shows the sixth step of dendrite formation, in which a current is applied in cycles to the anode 14 and cathode 15 of the battery by means of a current generator 19. Dendrites 18 formed in the cracks of the protonated layer 13 of the body 11 are observed. These dendrites 18 are blocked by the unprotonated part of the body 11, which is harder than the protonated layer 13.

The dendrites 18 are thin, elongated elements that extend into the protonated layer 13 from the anode 14.

This results in a battery 20 with an anode 14 and a cathode 15 on either side of the electrolyte 8, the body 11 having a protonated ceramic layer 13 and an unprotonated part superimposed on one another.

Such a battery 20 can be used in any electronic system, such as a watch, a drone, a mobile phone, a laptop computer, or even an electronic motor vehicle. In the case of a motor vehicle, the battery is of course larger in size.

It goes without saying that the invention is not limited to the embodiments described with reference to the figures and alternatives can be considered without leaving the scope of the invention.

1. A method for producing a solid-state battery with a solid electrolyte, comprising the following successive steps:
protonating a body containing a protonatable ceramic material, to form a protonated layer on the body;
depositing a metal element forming an anode on the protonated layer on a first side of the body;
assembling a cathode on a second side of the body, opposite the first side of the anode; and
forming dendrites from the metal element in the protonated layer of the body.

2. The production method according to claim 1, wherein the ceramic material is selected from:
doped or undoped lithium and/or lanthanum zirconium oxide, of the LLZO type,
a doped or undoped beta-alumina solid electrolyte material of the Na-b″-Al₂O₃ type,
a ternary, quaternary or higher order sulphide-based solid electrolyte material, including of the Li₆PS₅X type (where X is selected from the elements Cl, Br or I) or of the Li₂S—P₂S₅ type,
a ternary, quaternary or higher order halogen-based solid electrolyte material, including of the Li₃MX₆ type (where M is a metal or a metal alloy, and X is a halogen),
a lithium ion-conducting solid electrolyte material of the LISICON (lithium super ionic conductor) type, including of the Li_{4±x}Si₁₋ₓXₓO₄ type (where X is selected from the elements P, Al, or Ge), and
a sodium ion-conducting solid electrolyte material of the NASICON (sodium super ionic conductor) type, including of the NaₓMM′(XO₄)₃ type (where M and M′ are metals and X is selected from the elements Si, P or S).

3. The production method according to claim 1, wherein in the protonation step, the body is immersed in a protic or acidic solvent, including water, acetone, mineral oil or ethanol.

4. The production method according to claim 1, further comprising an additional step of heating the body to a predefined temperature in order to clean the body of impurities, the predefined temperature being between 350° C. and 450° C., the additional heating step preceding the step of depositing the metal element.

5. The production method according to claim 1, wherein the step of forming dendrites comprises a repeated succession of current flow cycles between the anode and the cathode.

6. The production method according to claim 1, wherein the metal element is melted onto the body during the metal element deposition step.

7. The production method according to claim 1, wherein the metal element contains a material to be selected from:
alkali-metals, including lithium, sodium, potassium, rubidium, caesium or francium,
alkaline-earth metals, including beryllium, magnesium, calcium, strontium, barium or radium,
all transition metals, which make up columns 3 to 11 of the periodic table, including lanthanides and actinides, and
alloys of these metals.

8. The production method according to claim 1, further comprising an additional step of removing a part of the protonated layer from the body in order to deposit the cathode directly onto the unprotonated part of the body.

9. The production method according to claim 8, wherein the additional step of removing a part of the protonated layer from the body is carried out by polishing the second side of the body.

10. The production method according to claim 1, wherein the cathode contains a material to be selected from:
a lithium-nickel-manganese-cobalt oxide of the NMC type, including LiNiₓMn_{y}Co_{z}O₂ or Li_{2-x-y-z}NiₓMn_{y}Co_{z}O₂ where x+y+z≤1,
a lithium-nickel-manganese oxide of the LNMO type, including LiNi_{0.5}Mn_{1.5}O₄,
a lithium iron phosphate oxide of the LFP type, including LiFePO₄,
a lithium manganese oxide of the LMO type, including LiMn₂O₄, and
a lithium-nickel-cobalt-aluminium oxide of the NCA type, including LiNiCoAlO₂.

11. A solid-state battery with a solid electrolyte comprising an anode, a cathode and a solid ceramic electrolyte, wherein the solid electrolyte is provided with a protonated layer and an unprotonated part superimposed on one another, the cathode being deposited on the body, the anode comprising a metal element deposited on the protonated layer of the body opposite the cathode, the metal element comprising dendrites having infiltrated the protonated layer of the body.

12. The solid-state battery with a solid electrolyte according to claim 11, wherein the dendrites are blocked by the unprotonated part of the body.

13. The solid-state battery with a solid electrolyte according to claim 11, wherein the metal element contains a material to be selected from:
alkali-metals, including lithium, sodium, potassium, rubidium, caesium or francium,
alkaline-earth metals, including beryllium, magnesium, calcium, strontium, barium or radium,
all of the so-called transition metals, which make up columns 3 to 11 of the periodic table, including lanthanides and actinides, and
alloys of these metals.

14. The solid-state battery with a solid electrolyte according to claim 11, wherein the ceramic material is selected from:
doped or undoped lithium and/or lanthanum zirconium oxide, of the LLZO type,
a doped or undoped beta-alumina solid electrolyte material of the Na-b″-Al₂O₃ type,
a ternary, quaternary or higher order sulphide-based solid electrolyte material, including of the Li₆PS₅X type (where X is selected from the elements CI, Br or I) or of the Li₂S—P₂S₅ type,
a ternary, quaternary or higher order halogen-based solid electrolyte material, including of the Li₃MX₆ type (where M is a metal or a metal alloy, and X is a halogen),
a lithium ion-conducting solid electrolyte material of the LISICON (lithium super ionic conductor) type, including of the Li_{4±x}Si₁₋ₓXₓO₄ type (where X is selected from the elements P, Al, or Ge), and
a sodium ion-conducting solid electrolyte material of the NASICON (sodium super ionic conductor) type, including of the NaₓMM′(XO₄)₃ type (where M and M′ are metals and X is selected from the elements Si, P or S).

15. The solid-state battery with a solid electrolyte according to claim 11, wherein the cathode is bonded to the unprotonated part of the body.

16. The solid-state battery with a solid electrolyte according to claim 11, wherein the cathode contains a material to be selected from:
a lithium-nickel-manganese-cobalt oxide of the NMC type, including LiNiₓMn_{y}Co_{z}O₂ or Li_{2-x-y-z}NiₓMn_{y}Co_{z}O₂ where x+y+z≤1,
a lithium-nickel-manganese oxide of the LNMO type, including LiNi_{0.5}Mn_{1.5}O₄,
a lithium iron phosphate oxide of the LFP type, including LiFePO₄,
a lithium manganese oxide of the LMO type, including LiMn₂O₄, and
a lithium-nickel-cobalt-aluminium oxide of the NCA type, including LiNiCoAlO₂.

17. An electronic system including a watch, a laptop computer, a mobile phone or a motor vehicle comprising a solid-state battery with a solid electrolyte, according to claim 11.
